(19) United States
(12) Patent Application Publication
(10) Pub. No.: US 2006/0080274 A1
(43) Pub. Date: Apr. 13, 2006

(54) Dynamic product association

(75) Inventor: Tamim Mourad, Los Angeles, CA (US)

Correspondence Address: INTELLECTUAL PROPERTY LAW OFFICE OF JOEL VOELZKE, 400 CORPORATE POINTE, SUITE 300, CULVER CITY, CA, 90230, US

(73) Assignee: PriceGrabber.com, LLC

(21) Appl. No.: 11/021,592

(22) Filed: Dec. 24, 2004

Related U.S. Application Data
(60) Provisional application No. 60/618,054, filed on Oct. 12, 2004.

(51) Int. Cl. G06F 17/30

(52) U.S. Cl. 707/1

(57) ABSTRACT

A software-based product identifier includes a description module that collects product description; a parsing module that parses the product description based on recognized attributes, don't care attributes, and unrecognized attributes. The product is identified and mapped to a predefined product based at least in part on the recognized attributes. The unrecognized attribute or attributes may serve as candidate model numbers for previously unknown products.

### CROSS-REFERENCE TO RELATED APPLICATIONS

The present application claims priority from U.S. Provisional Patent Application No. 60/618,054, filed on Oct. 11, 2004 and entitled “Dynamic Product Association,” which is hereby incorporated by reference in its entirety.

### BACKGROUND OF THE INVENTION

1. Field of the Invention

This invention relates to the field of product association. More particularly, this invention relates to the field of dynamic product association for use in comparison shopping systems.

2. Description of Related Art

For a variety of reasons, comparison shopping websites on the Internet have become popular with consumers. Typically, a merchant desiring to sell products through an affiliation with a comparison shopping site will electronically submit to the site operator information regarding the products the merchant is offering for sale, including a title for the product, a marketing description, a price, and in some cases a universal product code (UPC) or similar number such as a European Article Number (EAN) or an ISBN number in the case of books, that uniquely identifies the product in designated countries, or a model number that uniquely identifies that particular product from among the products offered by the specified manufacturer. For purposes of this discussion of the related art, the information regarding a product submitted by the merchant to the comparison shopping site operator will be called the product submission.

When the product submission includes a UPC in a UPC field within an electronic product submission form, the task of identifying all identical products submitted by different merchants and grouping those products together for side-by-side comparison on the shopping site is relatively straightforward. Additionally, when a product submission includes both a manufacturer name within a manufacturer field, and a model number within a model number field, the task of identifying all identical products submitted by different merchants and grouping those products together is also relatively straightforward.

### SUMMARY OF THE INVENTION

Product submissions by merchants to a comparison shopping site do not always include a UPC or a unique manufacturer and model number pair. In such cases, the task of identifying different submissions by different merchants can be complicated, time consuming, delay causing, and prone to error. The present invention addresses the problem of product submissions that do not contain a unique identifier or identifying combination of fields by providing a system and method for dynamically associating like products from different merchants, thereby facilitating product identification and product grouping, especially for use in comparison shopping services. The present invention provides an automated system and method for dynamically identifying and associating products when the product submissions by merchants, or other available information regarding the products, does not include a UPC or manufacturer and model number information. The invention therefore enables efficient implementation of comparison shopping sites for such products. In addition to comparison shopping sites, the invention has other applications for which it is desirable to automatically identify products, articles, or services.

The invention has potential use in a wide variety of other applications such as in inventory management, where different persons or the same person at different times may submit differing item descriptions and it is desirable to dynamically and automatically determine that two different item descriptions refer to identical items.

In one embodiment, a product or other item description, which will be referred to herein as a product title, is dynamically parsed into fields which may include any of the following: recognized attributes, unrecognized attributes, and don't care attributes. As used herein, a recognized attribute is an attribute that is recognized from among a predefined set of attributes. An example of a recognized attribute is the name of a manufacturer within a product title, and examples of values of the manufacturer attribute would be the names of known manufacturers. An unrecognized attribute is an attribute that is not a recognized attribute. That is, the system does not recognize what the alphanumeric string in question within the product description designates. A don't care attribute is an attribute that is determined to be not particularly helpful or determinative in identifying a product. In some cases a product can be uniquely identified from the recognized attributes. In other cases the recognized attributes are insufficient to uniquely identify the product, and the unrecognized attributes are then used as part of a candidate model definition for the product which may be a previously unidentified product. Once the product has been uniquely identified it can be dynamically associated with like products from other merchants, and comparisons of the like products can be presented to the comparison shopping site user.

In one exemplary embodiment, the present invention can be embodied in a computer software-based product identifier that includes the following: a description module adapted to collect a plurality of product descriptions; an attribute module adapted to determine a plurality of attributes that uniquely correspond to a particular product within a category; and an interrogator module adapted to interrogate the product descriptions with the attributes to identify each product description that corresponds to the particular product. According to an exemplary aspect of the invention, the product descriptions can be provided, such as electronically, for example and not in limitation, by merchants of the particular product.

In another exemplary embodiment, the present invention can be embodied in a computer software-based product identifier that includes the following: a description module adapted to collect a product description, corresponding to a particular product, and having a plurality of data instances respectively corresponding to product attributes; a parsing module adapted to parse the product description based at least in part on at least one recognized attribute and at least one unrecognized attribute; and a filler module adapted to define at least one filler attribute based at least in part on the at least one unrecognized attribute; where the product is uniquely identifiable based at least in part on the at least one filler attribute. The following are exemplary aspects of the invention: the product description can be parsed based at least in part on the at least one recognized attribute, the at least one unrecognized attribute and at least one null attribute, which can correspond to at least one stop word, for example and not in limitation.

In yet another exemplary embodiment, the present invention can be embodied in a computerized product identification method that includes the following acts: providing a plurality of product descriptions; determining a plurality of attributes that uniquely correspond to a particular product within a category; and interrogating the plurality of product descriptions with at least a portion of the attributes to identify each product description that corresponds to the particular product. According to an exemplary aspect of the invention, the product descriptions can be provided, such as electronically, for example and not in limitation, by merchants of the particular product.

In still yet another exemplary embodiment, the present invention can be embodied in a computerized method of identifying a product that includes the following acts: providing a product description, corresponding to the product, and having a plurality of data instances respectively corresponding to product attributes; parsing the product description based at least in part on at least one recognized attribute and at least one unrecognized attribute; and defining at least one filler attribute based at least in part on the at least one unrecognized attribute; where the product is uniquely identifiable based at least in part on the at least one filler attribute.

Exemplary embodiments of the invention will be further described below with reference to the drawings, in which like numbers refer to like parts.

### BRIEF DESCRIPTION OF THE DRAWINGS

The present invention is illustrated by way of example and not limitation in the figures of the accompanying drawings, in which:

FIG. 1 illustrates the parsing of a product description into recognized attributes, unrecognized attributes, and don't care attributes.

FIG. 2 illustrates an exemplary product identifier having a description module, an attribute module, and an interrogator module.

FIG. 3 illustrates another exemplary product identifier having a description module, a parsing module, and a filler module.

FIG. 4 illustrates acts of an exemplary product identification method according to the present invention.

FIG. 5 illustrates acts of another exemplary product identification method according to the present invention.

FIG. 6 illustrates steps of another embodiment, in which like products are identified based upon incomplete product information provided by a merchant.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concept to any particular configuration, order, environment, or application.

As a first example, a comparison shopping site might include a wine category of products or channel as it is sometimes called. A product submission by a merchant within the wine category might not include a UPC for the wine. The title for a bottle as submitted by a first merchant might be, “Granite Wine Cellars 2001 Eagle Crest Cabernet Sauvignon Gold Medal Winner.” Another title submitted by a second merchant might be somewhat different, but ultimately refer to the same wine. The present invention provides an automated method of associating the differently titled bottles of wine from the different participating merchants.

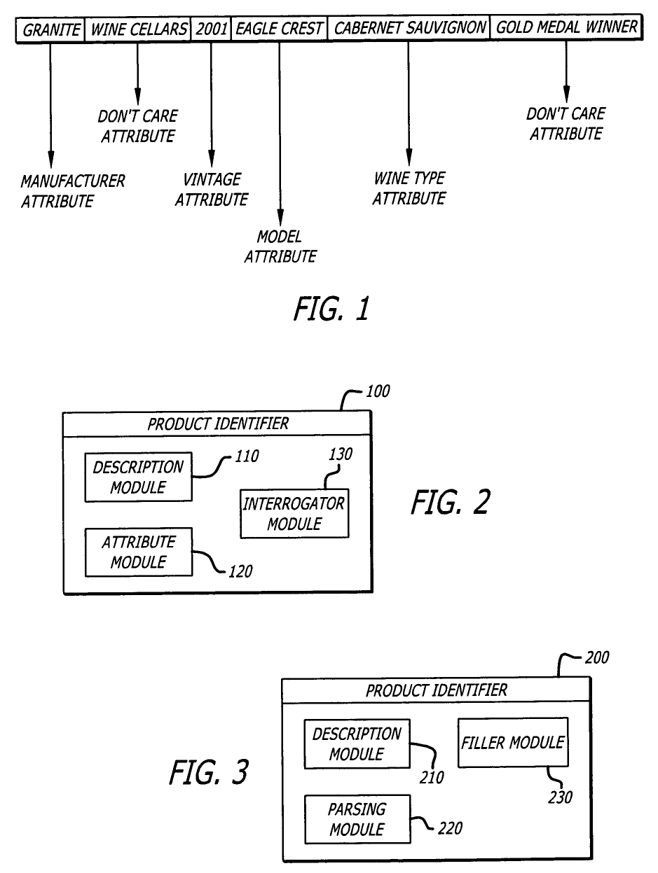

FIG. 1 shows the product description as submitted by the first merchant. The description is interrogated by an interrogation module to identify recognized attributes. The recognized attributes for wine could include manufacturer, vintage year, type of wine, and possibly size. The recognized attributes are identified and parsed out. In the example, the manufacturer is identified by the interrogation module as “Granite,” the vintage is identified as “2001”, and the type of wine is identified as “Cabernet Sauvignon.” The recognized attributes can be identified by a predefined list of possible attribute values (e.g., “Granite,” “Robert Mondavi,” “Geyser Peak,” etc. for the manufacturer, and “cabernet sauvignon,” “chardonnay,” etc. for the type of wine), a pattern (e.g., four digits for the vintage year, or a numerical value followed by “ml,” “oz” “liter,” etc. for a bottle size), or other techniques including pattern recognition, artificial intelligence, neural networks, and others. Rules are written to identify the attributes and their values. In the figure, “Granite” has been identified as the manufacturer attribute having a value of “Granite,” “2001” has been identified as the vintage attribute having a value of “2001,” and “Cabernet Sauvignon” has been identified as the wine type attribute having a value of “Cabernet Sauvignon.”

After the recognized attributes have been identified and parsed out, the remaining portion of the title in the example is “Wine Cellars Eagle Crest Gold Medal Winner.” This remaining portion is further interrogated to remove don't care attributes. Don't care attributes comprise text which will not be relied upon to identify the product and associate it with a model. Don't care attributes can include predefined stop words which are considered to be essentially meaningless, or at least immaterial in identifying the particular product to be identified. For example, within the wine channel stop words can include “wine cellars,” “vineyards,” “gold medal,” “winner,” “vintage,” etc. The title is therefore stripped of all don't care attributes. In the example, the string of alpha characters, or more generally alphanumeric characters, “Gold Medal Winner” has been identified as a don't care attribute, and the remaining title after the don't care attributes have been stripped is “Eagle Crest.” The order of stripping the recognized attributes and the don't care attributes from the title is not crucial. FIG. 1 shows the product description received from the merchant having been parsed into several recognized attributes, two don't care attributes, and one unrecognized attribute.

If the attributes identified so far are sufficient to uniquely identify the product, then a product match has been achieved. The product can be matched to other products submitted by other merchants and/or can be associated with a predefined name or number within an existing database. For example, the shopping site operator might assign its own product identification code to a particular item, or the operator might use the UPC for that product if a UPC for the product is known, even if none of the submitting merchants have used the UPC within their product submissions.

If the attributes identified so far are not sufficient to uniquely identify the product, then a next step is performed in which the unrecognized attributes are used to define a model. In the example, “Eagle Crest” is the remaining portion of the title, and “Eagle Crest” has not been predefined as a model. “Eagle Crest” is therefore the unrecognized attribute within this product title, and it is identified as the presumptive model for a new product previously unknown to the system. The product has therefore now been identified even though it was previously unknown to the system. When a second merchant submits a title for a second product within the wine channel and if, and after the foregoing process has been repeated for this second title, the second title is identified as having the same manufacturer, vintage year, wine type, and model as the first product, then the two products will be considered to be the same product. That is, the two products have been associated together. The shopping site can then treat the two products as being the same product for comparison shopping purposes, including presenting side-by-side for comparison purposes the two prices for this same product from the two different merchants. The present invention is not limited to one unrecognized attribute. More than one unrecognized attribute can be identified, and, if there are different combinations of those attributes present within submissions from different merchants, those different combinations can be presumed to constitute different model numbers to uniquely identify the product.

Different product or service channels will have different attributes. A fragrance channel, for example, could have the following attributes: manufacturer, size (e.g., 4.2 oz), dispenser (e.g., spray, splash), strength (e.g., eau de parfum, eau de toilette, eau de cologne, parfum), scent (e.g., Seventh Avenue), and gender (unisex, man, or woman). A recognition module can be employed using regular expressions and other known techniques to recognize and associate expressions within a product title to recognized attribute values. Attribute values that contain minor misspellings of manufacturers' names or other attribute values can be identified as such and correctly identified. Variations on ways to express the same value can be identified and associated, for example, “4.2 oz” and “4.2 ounce,” or “Seventh Avenue” and “7^{th} Ave.” Acronyms can be recognized as equivalent, e.g., “eau de parfum” and “EDP.” Foreign language equivalents can be recognized, e.g., “for men,” “pour homme,” and “pour les hommes.” Equivalent measures can be recognized, e.g, fluid ounces and cc's, including measures that are technically measures of different qualities but are colloquially used as equivalents, e.g. “1 kg” which is a unit of mass and “2.2 lbs.” which is a unit of weight or force. Colors can be equated especially where the product is sold in only certain colors but different merchants might describe the same colors differently, e.g., “cherry,” “fire engine,” and “red.”

For some channels and some products, a predefined set of attributes will be sufficient to uniquely identify a product offering and allow it to be definitively mapped to a product within the site operator's database. For example, for the fragrances channel the attributes of manufacturer, size, dispenser, strength, and scent, may be sufficient to uniquely identify the fragrance product without the need to examine any other strings within the product title submitted for recognized or unrecognized attributes.

FIG. 2 illustrates a computer software-based product identifier 100 according to an exemplary embodiment of the present invention, in which a description module 110 is adapted to collect a plurality of product descriptions such as the product description shown in FIG. 1; an attribute module 120 is adapted to determine a plurality of attributes that uniquely correspond to a particular product within a category; and an interrogator module 130 is adapted to interrogate the product descriptions with the attributes to identify each product description that corresponds to the particular product.

According to another exemplary aspect of the present invention illustrated in FIG. 2, description module 110 can collect product descriptions from one or more sources, which can include a database, for example and not in limitation. A product description can include any information regarding a product, such as at least one of a title, marketing description, price, etc., for example and not in limitation. Further, merchants can provide on-line access to product descriptions, in which case description module 110 can access the descriptions via one or more network channels, such as via the Internet, for example and not in limitation. Accordingly, the product descriptions can be from various merchants having various and/or identical products for sale, and can be provided or obtained in real-time for heightened accuracy of product information, such as price and available quantity, for example and not in limitation.

According to another exemplary aspect of the invention, attribute module 120 determines a plurality of product attributes that uniquely correspond to a particular product within a category. An attribute can correspond to any relevant product data such as manufacturer, size, weight, number, type of packaging, voltage, flavor, color, memory size, speed, class of product and model name, for example and not in limitation. For different products, different attributes must be defined and interrogated. For example, for a product category “perfumes,” attributes can include the following: manufacturer, size of bottle, type of dispensing unit (e.g., spray, splash), strength, and model name. Attribute module 120 can employ any one or more techniques in determining which, and how many, attributes are to be utilized to uniquely correspond to a particular product within a category, which will be apparent to one of ordinary skill in the art. In an exemplary aspect, the more attributes utilized, the higher the uniqueness accuracy is achieved, while concurrently, the higher the processing costs. For example, for a particular category of products, reference can be made to a master attribute list for specific categories of products, and utilized as is or adjusted as needed, such as via filler attributes as described below. Further, product attributes can be weighted based on their statistical relevance within product descriptions. Additionally, the number of variations of a product produced by a manufacturer can dictate how many attributes are required to uniquely identify a particular product.

According to a further exemplary aspect of the invention, interrogator module 130 interrogates the product descriptions with the attributes to identify each product description that corresponds to the particular product in question. For example, exemplary product descriptions can be interrogated with exemplary attribute data of the manufacturer's name, 4.2, Spray, Eau de Toilette and Seventh Avenue to uniquely identify a particular product for sale by various merchants who have submitted or made available product descriptions.

FIG. 3 illustrates a computer software-based product identifier 200 according to another exemplary embodiment of the present invention, in which a description module 210 is adapted to collect a product description, corresponding to a particular product, and having a plurality of data instances respectively corresponding to product attributes; a parsing module 220 is adapted to parse the product description based at least in part on at least one recognized attribute and at least one unrecognized attribute; and a filler module 230 is adapted to define at least one filler attribute based at least in part on the at least one unrecognized attribute.

Description module 210 is the same as description module 110 (described above).

According to an exemplary aspect of the invention, parsing module 220 parses the product description based at least in part on at least one recognized attribute and at least one unrecognized attribute. For example, with a product category “wine,” exemplary attributes can include manufacturer (e.g., Granite), vintage year (e.g., 2001), type of wine (e.g., cabernet sauvignon) and unrecognized attribute (Eagle Crest). Accordingly, the first three attributes are recognized and the last attribute is unrecognized, with the product description being parsed based thereon.

According to another exemplary aspect of the invention, filler module 230 defines at least one filler attribute based at least in part on the at least one unrecognized attribute. Thus, in the example above, the unrecognized attribute, which could correspond to a product attribute “model,” for example and not in limitation, can be defined as a filler attribute, which is one that can be utilized in rendering the exemplary wine product described above uniquely identifiable.

According to an exemplary aspect, filler module 230 can define filler attributes by reference to all, or a strategic subset of, products offered by a particular manufacturer, for example and not in limitation. Further, as the number and/or nature of products of a manufacture change (increase, decrease, change), filler module 230 can dynamically adjust filler attributes, which can be effectuated in real-time or close thereto. It should be noted, however, that filler module 230 can adjust filler attributes across other attributes in addition to, or instead of, manufacturer, for example and not in limitation.

According to another exemplary aspect of the invention, the product description can be parsed based at least in part on the at least one recognized attribute, at least one unrecognized attribute and at least one null attribute, which can correspond to at least one stop word, for example and not in limitation. In addition to stop words previously discussed, stop words can include other immaterial words such as “the,” “of,” “on,” and “a,” for example and not in limitation. Further, context-based language analyses can be optionally employed to assess the likelihood that an apparent stop word has no meaningful significance.

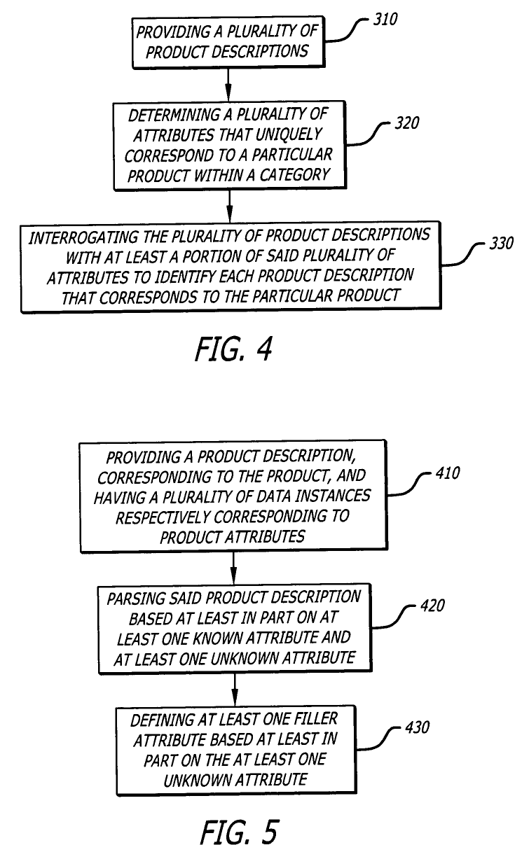

FIG. 4 illustrates yet another exemplary embodiment of the present invention, in which a computerized product identification method includes the following acts: providing a plurality of product descriptions (block 310); determining a plurality of attributes that uniquely correspond to a particular product within a category (block 320); and interrogating the plurality of product descriptions with at least a portion of the attributes to identify each product description that corresponds to the particular product (block 330). According to an exemplary aspect of the invention, the product descriptions can be provided, such as electronically, for example and not in limitation, by merchants of the particular product.

FIG. 5 illustrates still yet another exemplary embodiment, the present invention can be embodied in a computerized method of identifying a product that includes the following acts: providing a product description, corresponding to the product, and having a plurality of data instances respectively corresponding to product attributes (block 410); parsing the product description based at least in part on at least one recognized attribute and at least one unrecognized attribute (block 420); and defining at least one filler attribute based at least in part on the at least one unrecognized attribute (block 430); where the product is uniquely identifiable based at least in part on the at least one filler attribute.

Notably, the exemplary methods illustrated in FIGS. 4 and 5 are respectively symmetric to the program identifiers of FIGS. 2 and 3, as illustrated therein and described herein, and are intended to include equal, respective breadth.

As noted previously, the present method may be used in conjunction with a wide variety of products and services. A further, simple, non-limiting example is with prescription or non-prescription drugs. A drug merchant (which may be a retailer, wholesaler or other business entity) provides a product description of a drug. The description may include such variables as the drug manufacturer, drug brand, dosage size, the delivery type (e.g. a caplet or a tablet), and the number of delivery units. With this information, the system can create a “synthetic product identifier” for the product. The “synthetic product identifier” may alternatively be called a “synthetic SKU” or “synthetic UPC” or similar term. Any known system for assigning numbers or other alphanumeric or other code may be used including, as one non-limiting example, an autoincrementing integer scheme.

It is worth noting, however, that the minimum data needed to create an association may be defined in advance on the system. If some of that information is missing (e.g. if the retailer does not provide the number of delivery types, as one example), some embodiments of the invention will not create a synthetic product identifier. The system may reject that data from the merchant and may, for example, send the merchant an error message or otherwise indicate to the merchant that the data is incomplete.

Once the system has assigned a synthetic product identifier to a product, the same synthetic product identifier will be assigned to the drug products having the same data associated therewith. That way, like drug products can be grouped together.

The uses of the dynamic product association approach of the present invention are manifold. In one embodiment of the system, a user requests comparative price data from a variety of merchants for a particular drug product. The system then displays on a display the data (including price data) from like drug products. The system may have grouped the like drug products based upon incomplete data (e.g. data with no product identification number) provided from several different merchants, using the technology described herein.

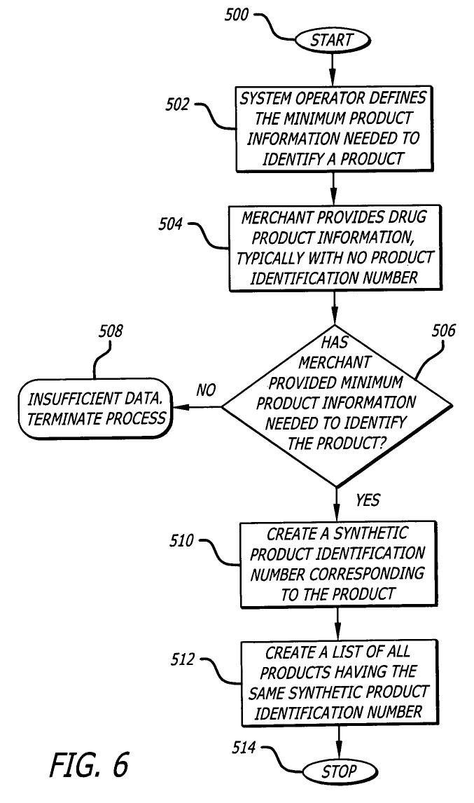

FIG. 6 illustrates the foregoing method. Starting at point 500, the system operator defines the minimum product information necessary in order to identify a product, at step 502. A merchant provides product information at step 504, typically without any product identification number. At step 506, the system checks the merchant-provided information to determine whether the merchant has provided sufficient product information in order to identify the product. If the merchant has not provided sufficient product information, the process stops at step 508. However, if the merchant has provided sufficient information, the system creates a synthetic product identification number or other identifier at step 510. At some point, for example at the prompting of a user who is conducting a search for all products of the same type, the system (at step 512) creates a list of all products having the same synthetic product identification number.

Although the method that FIG. 6 illustrates stops at step 514, the system may perform further steps as desired to implement any of a number of different applications. For example, the method may be incorporated into a website for selling products, and the further steps may include providing the user with one or more introductory screens, permitting the user to enter a search string for all products of a certain type, providing formatted output screens, providing screens for ordering products, and the like.

The product description can be obtained in ways other than receiving a product submission by a merchant. The operator of the comparison shopping site could obtain the product description in various ways, including: writing the description itself; reviewing a merchant's website either manually or automatically and incorporating the relevant product description; repeating titles and other information found in manufacturers' or merchants' catalogs, brochures, data sheets, websites, or other advertising, promotional, or informational literature in any form; and obtaining the product description from a third party. The invention is not limited by the manner in which the comparison shopping website operator has obtained the product descriptions.

It will be apparent to one skilled in the art that the manner of making and using the claimed invention has been adequately disclosed in the above-written description of the exemplary embodiments and aspects taken together with the drawings. It should be understood, however, that the invention is not necessarily limited to the specific embodiments, aspects, order, arrangement, and components shown and described above, but may be susceptible to numerous variations within the scope of the invention. Accordingly, the specification and drawings are to be regarded in an illustrative and enabling, rather than a restrictive, sense. The present invention could be used to identify numerous types of products including without limitation wine, fragrances, shoes, and clothing to name just a few. The present invention could also be used to identify services as well. The present invention could be used in any context in which it is desired to associate products and services, such as for use in comparison shopping sites, inventory management. Large government agencies historically sometimes struggle to effectively inventory and manage their assets which are scattered throughout a large geographic area and under the control of different organizations or divisions. As but one application, the present invention could be used to help identify the same products described using non-identical descriptions provided by different inventory takers operating in different locations and within different organizations divisions, to effectively recognize, associate, and group like products together for inventory purposes. Therefore, it will be understood that the above description of the embodiments of the present invention are susceptible to various modifications, changes, and adaptations, and the same are intended to be comprehended within the meaning and range of equivalents of the appended claims.

What is claimed is:

1. A computerized product identification system comprising:
a description module for receiving a product description;
an interrogation module for interrogating at least a part of the product description and identifying therein:
recognized attributes;
don't care attributes; and
unrecognized attributes;
an attribute matching module for matching values of the recognized attributes to predefined attribute values; and
a product identification module for uniquely associating the description to a predefined product.

2. The computerized product identification system of claim 1 further comprising:
a grouping module for associating together different items submitted by different merchants, the associated items having been identified by the product identification module as corresponding to the predefined product.

3. The computerized product identification system of claim 2 further comprising:
a comparison display module for causing to be displayed price comparison information regarding the associated items.

4. The computerized product identification system of claim 3 wherein the system is used on a comparison shopping website.

5. The computerized product identification system of claim 1 wherein said attribute matching module is capable of performing at least one of the following tasks:
identifying foreign language equivalents of attribute values;
identifying misspellings within attribute values;
identifying equivalent measures;
identifying alternative spellings;
identifying acronyms; and
identifying approximately equivalent values.

6. The computerized product identification system of claim 1, wherein the product description has been supplied to the system by a merchant of the product.

7. A computerized product identification method comprising:
receiving a plurality of product descriptions;
determining a plurality of attributes that uniquely correspond to a particular product within a category;
interrogating said plurality of product descriptions with at least a portion of said plurality of attributes to identify each product description that corresponds to the particular product.

8. A computerized product identification method as described in claim 7 wherein at least one of said plurality of product descriptions lacks a product identification number.

9. The method of claim 7 wherein the product descriptions are provided by merchants of the particular product.

10. The method of claim 7 wherein the product description lacks a product identification number.

11. A computer software-based product identifier comprising:
a description module adapted to collect a plurality of product descriptions;
an attribute module adapted to determine a plurality of attributes that uniquely correspond to a particular product within a category; and
an interrogatory module adapted to interrogate the product descriptions with the attributes to identify each product description that corresponds to the particular product.

12. The method of claim 11 wherein the product descriptions are provided by merchants of the particular product.

13. The method of claim 11 wherein at least one of said plurality of product descriptions lacks a product identification number.

14. A computerized method of identifying a product comprising:
receiving a product description corresponding to the product, and having a plurality of data instances respectively corresponding to product attributes;
parsing said product description based at least in part on at least one recognized attribute and at least one unrecognized attribute; and
matching product descriptions based on commonality of recognized and unrecognized attributes.

15. The method of claim 14 further comprising:
identifying attributes whose values do not substantially assist in product identification.

16. The method of claim 14 wherein said attributes whose values do not substantially assist in product identification comprise stop words used within an industry that do not limit a product.

17. The method of claim 14 wherein the step of receiving a product description comprises receiving a product description from a merchant of the product.

18. The method of claim 14 wherein said product description lacks a product identification number.

19. The method of claim 14 wherein said product description requires at least a required minimum of information about said product, and wherein the method includes the step of rejecting said product description if it does not include said required minimum of information.

20. The method of claim 14, further comprising the step of displaying matched product descriptions on a display in response to a user request for price comparison information between a plurality of merchants for said product.
